(19) United States
(12) Patent Application Publication
(10) Pub. No.: US 2007/0174766 A1
(43) Pub. Date: Jul. 26, 2007

(54) Hidden document data removal

(75) Inventors: Donald B. Rubin, Derwood, MD (US); William C. Neumann, Columbia, MD (US); Lauren Antonoff, Seattle, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/336,329

(22) Filed: Jan. 20, 2006

(51) Int. Cl. G06F 17/00

(52) U.S. Cl. 715/530; 715/500; 715/539

(57) ABSTRACT

Technology for finding and acting on hidden data contained in documents generated by a user in productivity applications is disclosed. The technology uses a user configurable document release policy file and a document inspector which parses a document file based on the configuration policy and either presents options to the user to make changes, implements changes automatically, or both, based on the policy definition. A method implemented at least in part by a computing device includes loading a user defined document policy configuration including data types identified as hidden data. A document is then parsed for the defined hidden data and a policy defined action is executed on the hidden data in the document in accordance with the document policy configuration.

### BACKGROUND

Productivity applications such as those available in the Microsoft® Office suite of applications allow users to create a number of different types of documents incorporating various types of data object. Such objects include text, images and multimedia components. Often, only portions of these objects are seen in the display version of the document, with some of the data the object contains being hidden for various reasons.

Individuals and organizations have implicit or explicit policies for releasing a document to others. For example, a consultant or a lawyer does not want to release a Microsoft® Word document to a client that includes hidden edits in the document and a government agency would not want to release a spreadsheet that has classified information in a hidden column of a spreadsheet. This document release problem also applies to any content within an organization that needs to be shared with external entities.

Currently, there are only limited mechanisms for removing “hidden data” from such applications. As used herein, “hidden data” includes three types of information; metadata (name, value pairs), state (control) information, and content. The content category can be further subdivided into two categories: internal and external. Internal content is recognized and directly manipulated via the application being used. Storage of internal content is clearly defined within a file format. Internal hidden content can be inserted by users, such as hidden spreadsheet columns, off-page content, and overlapping or embedded objects. External content is treated as a separate entity associated via Object Linking and Embedding (OLE) with another application responsible for presentation and activation. External content can be added to a document via copy-paste operations or explicit object insertions (or links).

Previous efforts to address hidden data have included a variety of techniques to manage these types of hidden data. For example, Microsoft® produced two versions of a Remove Hidden Data (RHD) tool, RHD 1.0 and RHD 1.1. The first tool operated on a store file to remove a number of different types of hidden data. This required significant processing time and the tool had a limited user interface. The second version of the tool removed fewer types of hidden data, and therefore took less time to process, but was less comprehensive. Both tools operated on stored Office files. Recently the Navy Special Security Office developed an RHD tool that worked by first converting Microsoft® file formats to Open XML and then post-processing the XML data to detect a variety of hidden data. This produced a report that described a fixed and limited set of hidden data that required the user to go back into the Office document, find the hidden content based on the report, examine it for sensitive data and then keep it, edit it, or remove it as appropriate. In each case, the tools simply removed the hidden data found.

### SUMMARY

Technology is disclosed which allows users to identify hidden data contained in documents generated by productivity applications. The technology makes use of a user configurable document release policy file, and a document inspector which parses a document based on the configuration policy. Options may then be presented to the user to make changes, changes implemented automatically, or both, depending on the policy definition. The policy allows one to define the inspector interaction with the document object model to remove hidden data where appropriate, and/or insert unique comments and/or highlights into the document that a user will use to find hidden content when the type of hidden content requires human review.

In one aspect, a method implemented at least in part by a computing device is disclosed. The method includes loading a user defined document policy configuration including data types identified as hidden data. A document is then parsed for the defined hidden data and a policy defined action is executed on the hidden data in the document in accordance with the document policy configuration.

In another aspect, a method implemented at least in part by a document generation application program in a computing device is disclosed. The method includes loading a user defined document policy configuration and parsing a document for the hidden data. A list of the hidden data is provided in an interface to the user, the interface including a link redirecting the application program to display the location of the hidden data in the document.

In another aspect, a computer-readable medium in a computer having computer-executable components including an application program suitable for generating a document is provided. The computer readable medium includes a hidden document data policy definition file; and a policy execution component. The policy execution component includes a hidden data mark-up component responsive to the document policy definition and a hidden document data defined action execution component instructing the application program.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a depiction of a processing device suitable for implementing the technology discussed herein.

FIG. 2 is a logical depiction of the system memory and non-volatile memory showing components of the technology implemented herein.

FIG. 3 is the depiction of a document release policy for use in accordance with the technology discussed herein.

FIG. 4 is a flowchart illustrating a method for performing a document release review.

FIG. 5 is a method for displaying a user interface in accordance with step 410 of FIG. 4.

FIG. 6 is a second method for presenting data choices to a user in accordance with step 410 of FIG. 4.

FIG. 7 is a depiction of a first user interface presented in accordance with FIG. 4.

FIG. 8 is a depiction of a second user interface presented in accordance with FIG. 5.

### DETAILED DESCRIPTION

The technology disclosed herein allows users to identify potentially sensitive information contained in documents generated by the user in productivity applications, based on a configurable document release policy. In one embodiment, the policy is provided in XML format which is executed by a document inspector. The document inspector parses a document (or document data file) based on the configuration policy and either presents options to the user to make changes, implements changes automatically, or both, based on the policy definition. The policy allows one to define the inspector interaction with the document to mark and/or remove hidden data where appropriate. Marking may include inserting unique comments and/or highlights into the document that a user can use to find hidden content when the type of hidden content requires human review.

A document may be any file in any format for storing data for use by an application on a storage media. In particular, documents refer to any of the files used by the productivity applications referred to herein to store objects which may be rendered.

In one implementation, the technology is implemented as an add-in which can interact with other components in the productivity application. As discussed below, when the productivity applications comprise the Microsoft® Office suite of applications, the Office Task Pane can be used to produce a summary report of the actions taken by the add-in and provide additional textual and graphical information that can assist the user in finding hidden content. Once the user has reviewed the document and edited/removed all sensitive content they can click on a Finish button that causes the add-in to remove the comments and/or highlights and save the sanitized file for subsequent release. The user experience is streamlined since the user remains in the application and uses the native application tools to reveal the hidden content, inspect it, and edit or delete it where appropriate. This overcomes shortcomings in previous attempts to address this issue that dealt with automatic deletion of hidden data and did not provide users with a means of inspecting, editing, and/or removing hidden content types that require human review.

An additional feature of the invention is that it is policy driven through an XML file that can be customized. This capability permits a user or an organization to dictate the types of data that is wants detected (as well as actions, such as always delete) as part of its document release policy.

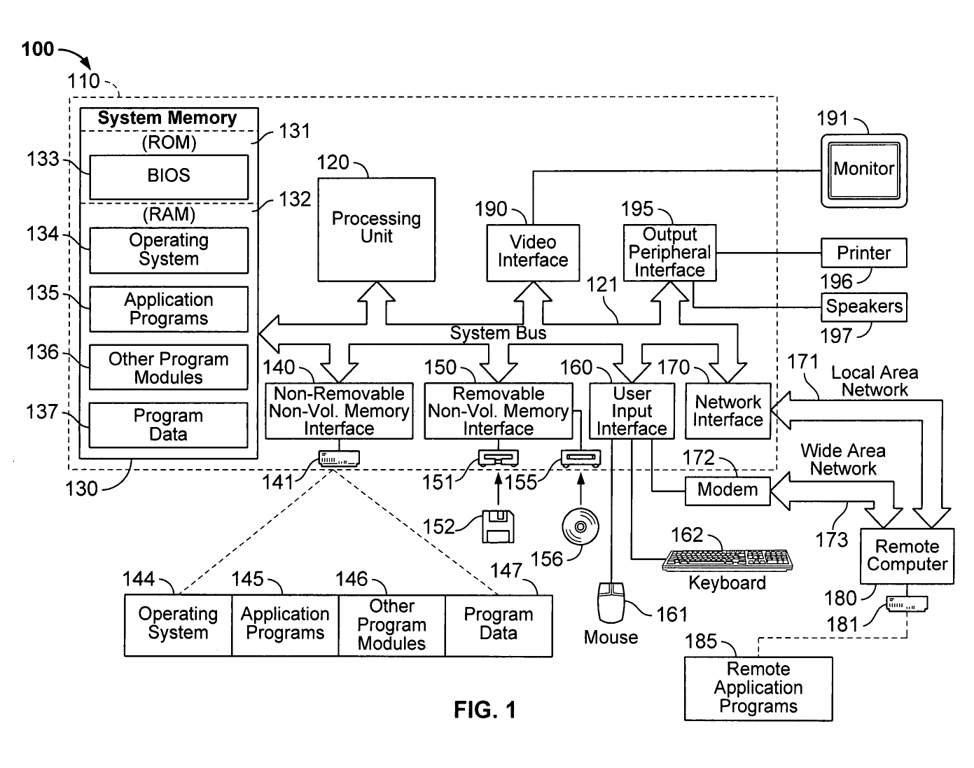

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the technology herein includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

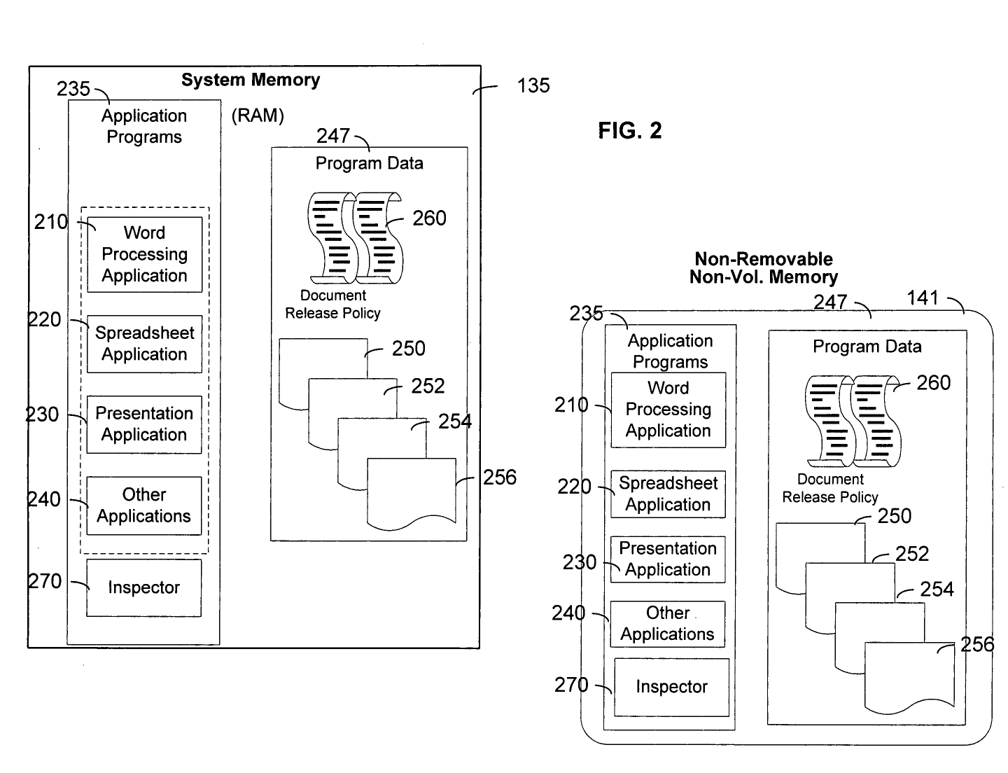

FIG. 2 is a logical depiction of the components of the technology discussed herein in the system memory 130 and the non volatile memory 141 depicted in FIG. 1. As illustrated therein, a number of application programs 235 may include, for example, productivity applications such as a word processing program 210, a spreadsheet application program 220, a presentation application program 230, and other applications 240. Each of the applications may be stored in non-volatile memory and executing components included in system memory 135. In addition, program data 247 can include a number of documents 250, 252, 254, 256, and one or more document release policies 260.

In accordance with the techniques discussed herein, the document release policy is a definition of a set of data which a user or other configuring entity has determined to be of concern prior to release of the document beyond the user or entity. The policy includes definitions on how to deal with different types of data which may be overlooked before release, outside the viewable scope of a user in the document. The application programs may use a common document object model common document object model or other programmatic access to document content, which in one embodiment may be an XML document model, which may be parsed by an inspector application 270. Alternatively, the inspector application may parse the actual document file in order to work around any potential limitations which may appear in the document object model. Inspector application 270 may be a separate application developed for the specific purpose of parsing the document, a built-in component of a suite of productivity applications, or an add-in to one or more of the application program 210, 220, 230, 240.

It should be understood that the application programs 235 shown in FIGS. 1 and 2 may include, for example, the Microsoft Office suite of programs, including Microsoft Word, Microsoft Excel, Microsoft PowerPoint, and other Office programs. In one embodiment, these programs use an extensible file definition format—Microsoft's Open XML format—to store documents. Alternatively, the OASIS Open Document Format for Office Applications may be used. Both formats include a ZIP container for XML and other data files. Both structures use a set of conventions for structuring a document. The format describes what the content types of parts within the document, including root level relationships. Relationships in the document control references from one part in the file to another part. The document inspector can quickly scan a package and determine the parts that make up that document and how they relate. Alternatively, an inspector application may inspect the actual document or other stored document file formats.

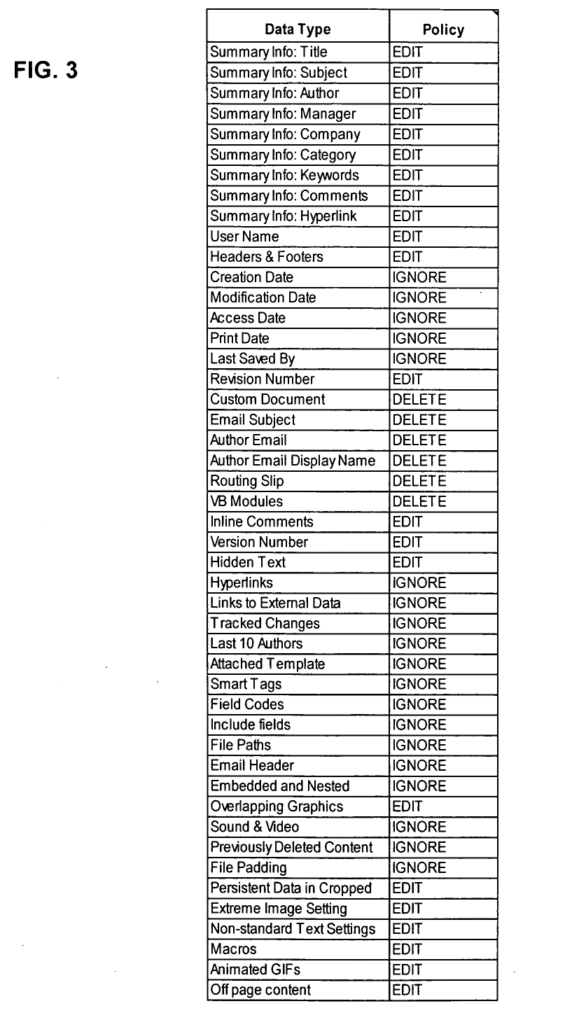

FIG. 3 illustrates an exemplary hidden document data policy which may be defined by a user or controlling entity in accordance with the technology discussed herein. The policy includes a data type and an action definition. FIG. 3 is exemplary and numerous other types of data which a user or entity may be concerned with may also be defined in the policy.

The policy actions disclosed in FIG. 3 include “Edit”, “Delete”, and “Ignore”. As will be discussed below, each of the these action definitions creates an instruction for the inspector to either present an interface to the user to allow the user to make a choice about what to do with the data type, automatically delete the data type, or simply ignore this data type in this policy.

Many of the data types illustrated in FIG. 3 are readily familiar to a user of productivity application programs such as that described above. For example, the “summary info” is information which may be inserted by an application program into a separate summary metadata area of the document identifying aspects of the document. Generally, such information is not available upon viewing the document itself, but can be accessed by reference to a file “View Document Properties” command in the application program.

The “user name” data is generally defined on a global level by the application programs. Normally, users can override this information and overriding the data in any one of the application programs 210, 220, 230, 240 will override it in other programs. Headers and footers are not normally viewable in one of a number of view modes in the application programs. In some entities, headers and footers are used to identify document classification. In the policy shown in FIG. 3, the policy defines this information should be automatically deleted before the document is released. Some information such as creation date, modification date, and access date may not be kept within the document 250, but are so called “external” content, recorded within a separate file in the operating system. The inspector can review files associated with the document files which may store information concerning the document files.

Three types of hidden data which may not be readily apparent to a user include overlapping graphics, non-standard text headings, and off-page content. Overlapping graphics can occur when users place two different graphic files such as image files in a document and a portion of one of the images is obscured by the other, or when an image overlays text in the document. While the image may display correctly on the screen, the hidden content “below” the obscuring content can result in potentially sensitive information being disclosed. Non-standard text headings include text which may have been minimized to a level that it becomes invisible to the viewer of the document during a normal print or screen view. Text may be reduced to a font size which is imperceptible to the user, or may be colored the color of the background, but may contain sensitive information. The non-standard text headings can include a definition requiring all text smaller than a certain size to be addressed by the document inspector tool. Off-page content occurs when an image, chart or other embedded object is dragged off a page. An object can be totally dragged outside the boundary of a page and disappears without being able to be retrieved. Nonetheless, the data remains in the file and may contain sensitive information not visible to the user. The document inspector is capable of finding each of these particular types of information within the common object model utilized by the application programs.

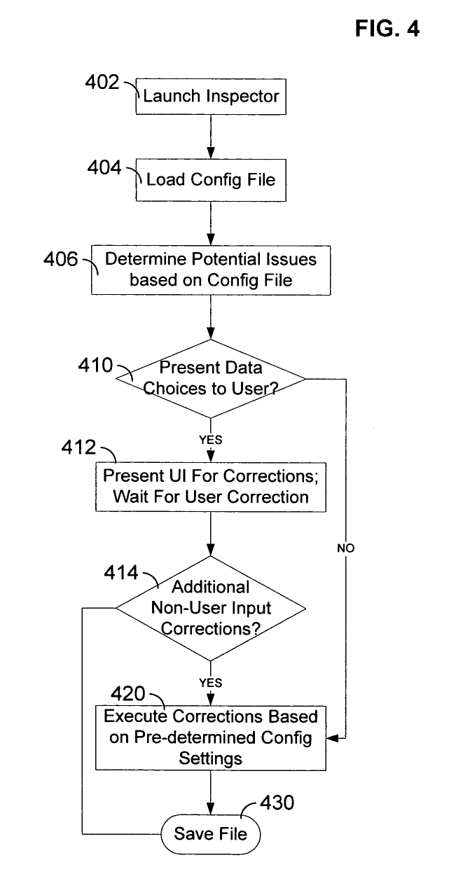

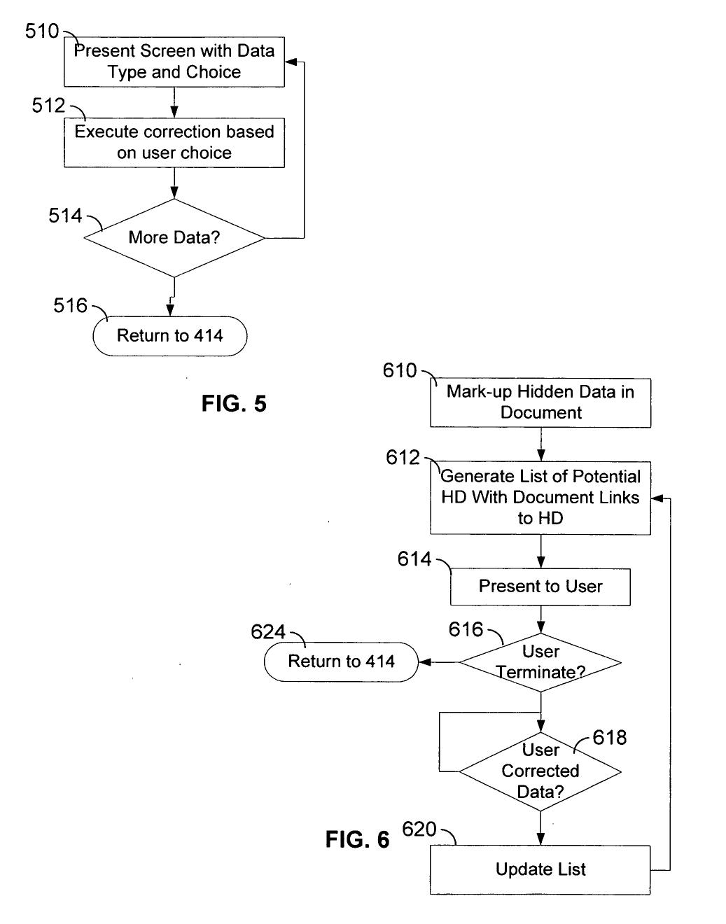

FIG. 4 illustrates a method for removing hidden data from a document. In step 402, the user or entity will launch a document inspector application or component. As noted above, the document inspector includes the ability to parse the document with an understanding of the document object model to find data meeting the criteria defined in the policy. In one embodiment, the inspector is launched by a user while operating one or more of the application programs shown in FIG. 2. In this context, user interfaces disclosed with respect to FIGS. 5-8 may be presented. Alternatively, the inspector tool may be launched by an automatic process, such as an outbound e-mail process or a save to a particular server or directory on a server, causing inspection of the document prior to the document being released outside of a controlling entity or stored to a particular location.

At step 404, the policy file configuration is loaded. As discussed above, the policy will contain definitions which may require automatic actions on the part of the method, or allow user interaction with certain types of potentially hidden data. At step 406, the method determines whether any data meeting the policy definition is included in the document. In one embodiment, where the user is operating the program in the context of the application program, the determination step will occur on a document presently in use by the application in the system memory. In another alternative, the tool and the determination can be launched on a stored file and brought into stored memory and loaded into the application for use by the inspector tool.

At step 410, a determination is made as to whether or not data choices are to be presented to the user. If the XML policy defined in FIG. 3 includes only delete and ignore commands, this determination will be negative and the method will continue to step 420 where it will automatically execute any delete commands on the data as defined in the policy. If data choices are to be presented to the user, then at step 412, a user interface such as that disclosed in FIGS. 5-8 is presented to the user and the user is allowed to make edits to the data in accordance with the type of interface presented. At step 414, once the user edits are completed, the system checks to determine whether any additional non-user input corrections need to be made. For example, all of the edit policy decisions can be made a step 412, while all the automatic delete decisions can be implemented at step 420 if non-user input corrections are to be made at step 414. If no additional non-user input corrections are made at step 414 or corrections are finished executing at step 420, the file can be saved and is ready for release.

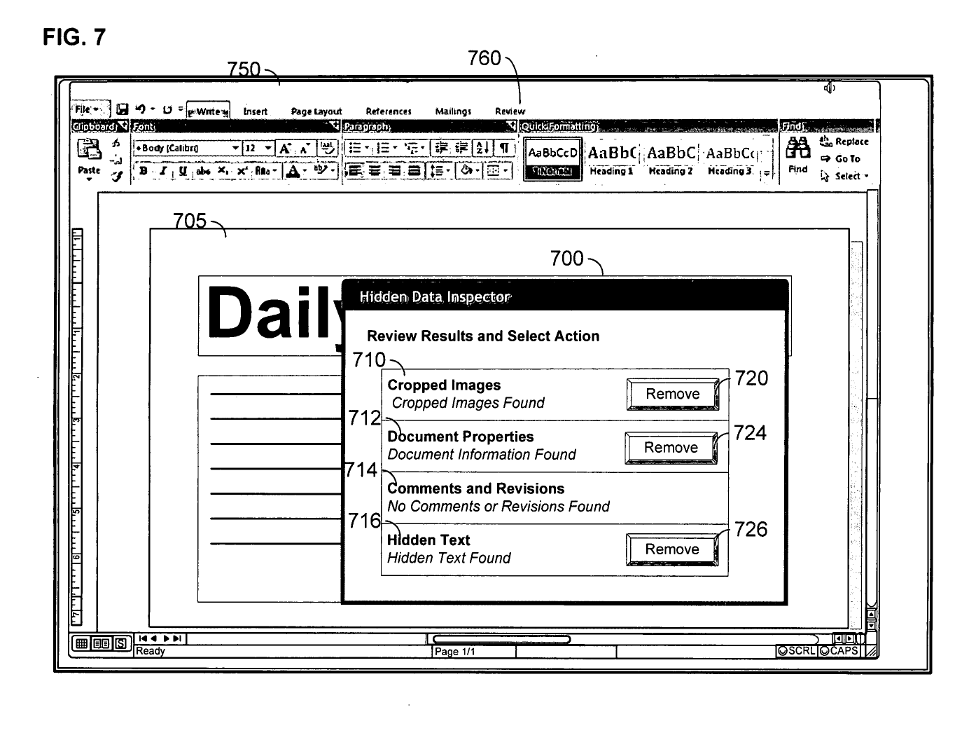

FIG. 5 illustrates a first method for implementing step 412 by presenting a user interface to a user and allowing the user to make edits. FIG. 5 will be discussed in conjunction with FIG. 7, which shows a selection-driven interface operating in conjunction with a word processing application, such as Microsoft Word. FIG. 7 illustrates an application 750 running on a user interface 760. The application includes familiar menu commands in a display window and contains a document 705 in system memory.

Following parsing of the document by the inspector, at step 510, a pop-up window 700 may be presented to the user illustrating certain types of data which the inspector determines is problematic based on the policy. The user is prompted to select whether or not to remove such data based on the type of data which is found. For example, in FIG. 7, the inspector has found cropped images, document properties, and hidden text. No comments or revisions have been found. If the user selects the remove button 720, 724, or 726, for any or all of the found data types, the inspector tool can execute at step 512 a correction based on the user choice. In this example, the correction is to “remove” the data, however other correction techniques are possible. For example, the policy may contain instructions to insert generic or non-descriptive text or meta-data into fields of data it finds. In this example, the user is not presented with a choice on how to edit the data, but merely whether or not to delete it.

At step 514, a determination is made as to whether more data exists which needs to be presented to the user. In the interface of FIG. 7, space may be limited and additional windows may need to be displayed to encompass all data types.

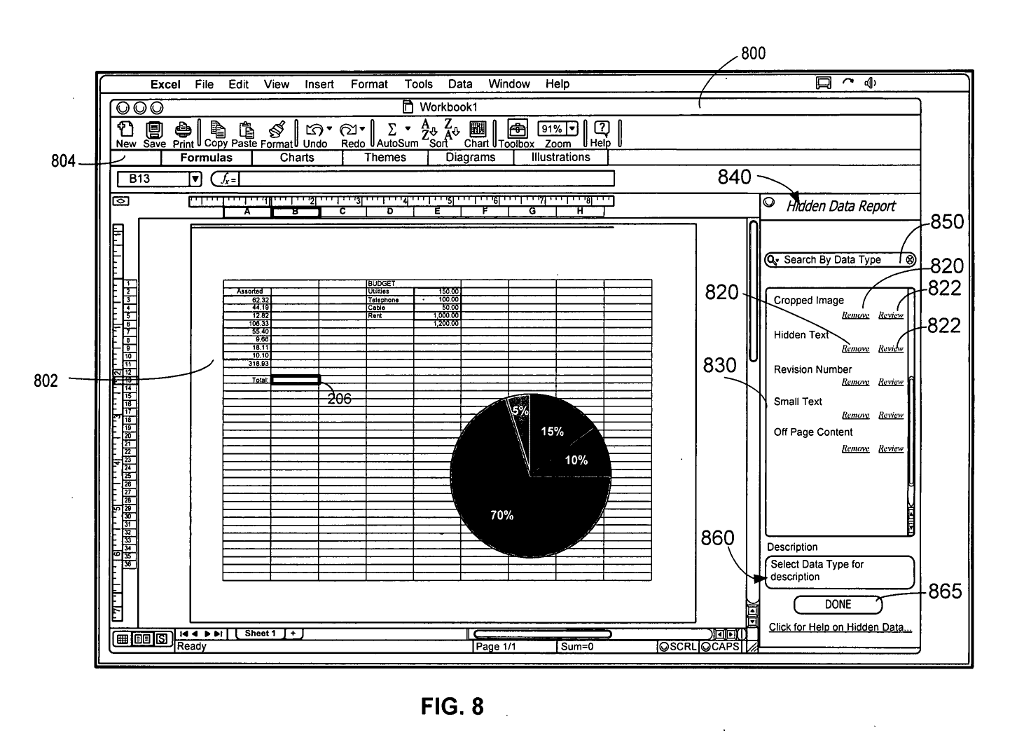

FIG. 6 shows a second alternative for implementing the user interface and corrections at step 412. FIG. 6 will be discussed with respect to FIG. 8 which illustrates an editing interface used with a spreadsheet application, such as Microsoft Excel. The spreadsheet application program includes a graphical user interface is including spreadsheet window 800 having spreadsheet 802 and tools 804 for entering and managing information on spreadsheet 802. Spreadsheet 802 may consist of rows and columns of individual cells 206.

At step 610, in accordance with the document policy definition, any hidden data defined for the user to “Edit” in the policy of FIG. 3 is marked-up in the document. Each of the aforementioned application programs includes the facility to format text and present text in an easily discernible fashion to the user. For example, text in a word processing document can be marked with a highlighted color, flashing text, or text with a filled background. These markings can give the text, or any data object so marked, a unique appearance on the screen. As such, any hidden data which is marked for user editing is marked in manner which is easily perceptible to a user within the application itself.

At step 612, a list of all marked data is generated by type, and at step 614 the user is be presented with a list of editable hidden data items with links to the particular information within the document being generated.

Referring to FIG. 8, a list 830 is presented in a task pane on one side of the spreadsheet or document. Task pane 840 includes a list 830 of hidden data items which are defined in accordance with the policy shown in FIG. 3. In this case, the inspector has found a cropped image, hidden text, a revision number, small text, and off-page content. For each of the listed types, the user is provided both the ability to review by selecting the review link 820 and remove the data by selecting the remove link 822. If the user selects the review link 820, the link causes the application to reposition the document to the location of the hidden data. The user then has the opportunity to correct the data within the application at the location in the document where the hidden data exists.

If the user does correct the data, at step 618 the list presented to the user can be updated at step 620 and the updated list regenerated at step 614 and a new list presented to the user at step 614. This loop continues until the user terminates the review process at step 616 and the method continues at step 414 as discussed above.

It should be recognized that any number of user interfaces presenting a review method to the user may be utilized. In a unique aspect, the technology uses the editing capabilities and presentation capabilities of the application program itself to present the hidden data to the user by marking the data in a fashion which can be easily discernible by the user. Standard linking techniques to the data objects within the documents are utilized to present links such information to the user in the user interface. In this manner, editing of the hidden data can be performed within the application program itself.

In addition, the types of objects and data reviewed by the application. For example, the inspector may include the ability to search for digital media which is the subject of copyright protection. In such case, the document release policy may include a warning action generating a flag to a user to warn the user to ensure that appropriate licenses for the subject matter are within the control of the user or controlling entity.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method implemented at least in part by a computing device, comprising:
loading a user defined document policy configuration including data types identified as hidden data;
parsing a document for the hidden data; and
executing a policy defined action on the hidden data in the document in accordance with the document policy configuration.

2. The method of claim 1 wherein the user defined document policy includes a data type and a policy defined action associated with each data type.

3. The method of claim 1 wherein the step of executing occurs in an application program suitable for generating said document.

4. The method of claim 1 wherein the policy defined action includes automatically deleting the hidden data.

5. The method of claim 1 wherein the policy defined action includes presenting an edit interface to a user in an application program suitable for generating said document.

6. The method of claim 5 wherein the step of presenting includes marking the hidden data in a user discernable manner.

7. The method of claim 5 wherein the step of presenting includes providing a list of hidden data in the document, the list including a link redirecting the application program to display the hidden data in a user interface of the application.

8. The method of claim 5 wherein the list includes a remove link causing the application program to delete the data.

9. The method of claim 5 wherein the method includes the step of receiving an edit to the hidden data and updating the list based on the edit.

10. The method of claim 1 wherein the document policy definition is in XML format.

11. A method implemented at least in part by a document generation application program in a computing device, comprising:
loading a user defined document policy configuration;
parsing a document for hidden data as defined in the document policy configuration; and
providing a list of the hidden data in an interface to the user, the interface including a link to the hidden data in the document

12. The method of claim 11 further including the step of automatically executing a policy defined action on the hidden data.

13. The method of claim 11 wherein the step of providing includes marking the hidden data in the document generation application program in a user discernable manner.

14. The method of claim 11 wherein the list includes a remove link causing the application program to delete the hidden data.

15. The method of claim 11 wherein the method includes the step of receiving an edit to the hidden data and updating the list based on the edit.

16. A computer-readable medium in a computer having computer-executable components including an application program suitable for generating a document, comprising:
a hidden document data policy definition file; and
a policy execution component including a hidden data mark-up component responsive to the document policy definition and a hidden document data defined action execution component instructing the application program.

17. The computer readable medium of claim 16 wherein the data markup component executes with the application program to mark a document in the application program.

18. The computer readable medium of claim 16 further including a user interface component including a hidden data list generator.

19. The computer readable medium of claim 16 wherein the list generator component includes a link generator attaching hidden data locations in a document to the list.

20. The computer readable medium of claim 16 wherein the hidden policy document policy definition file is in an XML format.
